(19) United States
(12) Patent Application Publication
(10) Pub. No.: US 2026/0350148 A1
(43) Pub. Date: Nov. 5, 2026

(54) Intelligent Alert Remediation Using Large Language Models (LLMs) and Retrieval-Augmented Generation (RAG)

(71) Applicant: Zscaler, Inc., San Jose, CA (US)

(72) Inventors: Eden Meyuhas, Holon (IL); Shoham Danino, Tel-Aviv (IL)

(73) Assignee: Zscaler, Inc., San Jose, CA (US)

(21) Appl. No.: 19/195,899

(22) Filed: May 1, 2025

(51) Int. Cl. G06F 21/55

(52) U.S. Cl. CPC G06F 21/552; G06F 2221/034

(57) ABSTRACT

Systems and methods for providing intelligent alert remediation recommendations include receiving a security alert from an External Attack Surface Management (EASM) platform; extracting metadata and contextual information from the security alert and converting the extracted metadata and contextual information into a vector embedding; performing a similarity search over a knowledge base comprising structured and unstructured data using the vector embedding to retrieve relevant remediation data; and generating, via a Large Language Model (LLM), remediation recommendations based on a context-aware prompt constructed from the retrieved data and the alert information.

### FIELD OF THE DISCLOSURE

The present disclosure relates generally to computing. More particularly, the present disclosure relates to systems and methods for intelligent alert remediation using Large Language Models (LLMS) and Retrieval-Augmented Generation (RAG).

### BACKGROUND OF THE DISCLOSURE

Modern cybersecurity environments are characterized by an ever-evolving threat landscape, where organizations must continuously monitor and protect an expansive external attack surface. External Attack Surface Management (EASM) platforms play a crucial role in identifying vulnerabilities and potential threats across digital assets. However, these platforms often generate a high volume of complex alerts, each requiring timely and context-specific remediation. Existing alert management systems are limited by their reliance on static, generic recommendations that lack the context-aware adaptability necessary to address the intricacies of individual security threats. This deficiency places a significant burden on security teams, who must manually interpret alerts, determine optimal remediation steps, and implement them, often under tight time constraints. Traditional solutions struggle to keep pace with the dynamic nature of cybersecurity threats due to key limitations such as the absence of interactive guidance, poor integration with historical data, and a lack of responsiveness to emerging threats. As a result, there is a pressing need for a more intelligent, adaptive, and user-centric approach to security alert remediation. The present invention addresses these challenges by introducing a novel system that leverages Large Language Models (LLMs) and Retrieval-Augmented Generation (RAG) techniques to deliver intelligent, context-aware security alert remediation recommendations.

### BRIEF SUMMARY OF THE DISCLOSURE

The present disclosure includes methods having steps, processing devices configured to implement the steps, a cloud-based system configured to implement the steps, and as a non-transitory computer-readable medium storing instructions for programming one or more processors to execute the steps. In various embodiments, the steps include receiving a security alert from an External Attack Surface Management (EASM) platform; extracting metadata and contextual information from the security alert and converting the extracted metadata and contextual information into a vector embedding; performing a similarity search over a knowledge base comprising structured and unstructured data using the vector embedding to retrieve relevant remediation data; and generating, via a Large Language Model (LLM), remediation recommendations based on a context-aware prompt constructed from the retrieved data and the alert information.

The steps can further include presenting the remediation recommendations through an interactive conversational interface. The steps can include receiving user input via the interactive conversational interface and providing follow-up guidance based thereon. The steps can include integrating the remediation recommendations with workflows and features of the EASM platform for implementation. The knowledge base can be continually updated with threat intelligence and historical remediation data. The steps can include updating the knowledge base with newly generated recommendations and associated outcomes and incorporating updates into future processes to enhance recommendation precision. The steps can include incorporating user feedback into the knowledge base to improve future recommendations. Remediation recommendations can be dynamically adapted to an organization's risk posture and emerging cybersecurity threats. The steps can include enabling the user to request automation scripts or detailed instructions for implementing the remediation within the EASM platform. The steps can include aggregating structured data and unstructured data retrieved via Retrieval-Augmented Generation (RAG) into a unified dataset for input to the LLM.

### BRIEF DESCRIPTION OF THE DRAWINGS

The present disclosure is detailed through various drawings, where like components or steps are indicated by identical reference numbers for clarity and consistency.

FIG. 1 is a block diagram of a computing system 100 that may be used to implement various components described in this disclosure.

FIG. 2 is a flow diagram illustrating a workflow of an automated cybersecurity threat detection system.

FIG. 3 is a flowchart of a process for automated threat analysis and detection.

FIG. 4-FIG. 8 includes various screenshots of an interactive User Interface (UI) for presenting enriched CVE information.

FIG. 9 is a flowchart of a process for automated threat analysis and detection.

FIG. 10 is a flowchart of a process 1000 for providing intelligent security alert remediation recommendations.

### DETAILED DESCRIPTION OF THE DISCLOSURE

The present disclosure relates to systems and methods for automated threat analysis and detection using generative AI. Retrieval-Augmented Generation (RAG) frameworks represent a significant advancement in AI, combining retrieval-based methods with generative models to enable context-aware and dynamic decision-making. In cybersecurity, RAG frameworks can be used to correlate internal system data with external threat intelligence, allowing for real-time identification of anomalies and potential threats. The invention described herein leverages these advancements to provide a comprehensive cybersecurity threat detection system. By integrating system logs with cloud nano log data and utilizing a generative AI model within a RAG framework, the system is capable of proactive, automated threat detection. The inclusion of a live data crawler ensures continuous updates from external threat intelligence sources, while a high-performance vector store and semantic chunking strategy enable efficient data retrieval and analysis. This innovative approach marks a paradigm shift from static rule-based systems to dynamic, AI-driven threat detection. It enhances the accuracy, scalability, and responsiveness of cybersecurity defenses, empowering organizations to detect and respond to threats more effectively while reducing dependence on manual processes and expert intervention.

The present disclosure further relates to automated CVE enrichment and vulnerability analysis. The described system leverages advanced technologies, including Large Language Models (LLMs), to process raw CVE descriptions and produce structured, human-readable outputs in formats such as JavaScript Object Notation (JSON). These outputs encompass over 40 enriched attributes, including enhanced publication metadata, vulnerability overviews with upgrade paths, multi-level examples tailored to different user expertise levels, and detailed attack vectors with corresponding defense recommendations. A core innovation of the system lies in its seamless integration with security frameworks, mapping CVEs to probable and possible attacker tactics and techniques. This mapping is enhanced by justifications and visual attack flow representations, enabling a deeper understanding of real-world exploitation scenarios.

The present disclosure further relates to intelligent security alert remediation recommendations. Various embodiments include the ability to analyze incoming security alerts, extract relevant metadata, and generate vector embeddings for efficient retrieval of related historical and technical data. Through RAG, the system dynamically pulls from a continuously updated knowledge base, blending structured remediation procedures with unstructured real-world case data. This ensures that recommendations are grounded in both up-to-date threat intelligence and practical remediation experience. The system's LLM capabilities enable it to generate detailed, actionable remediation steps that are customized to the context of each alert and the specific environment of the organization. Its conversational interface empowers users to engage with the system, ask follow-up questions, and refine their remediation strategies in real time. Moreover, by providing implementation guidance specific to the integrated EASM platform, the system removes ambiguity and facilitates efficient execution of security measures.

### Example Computing System Architecture and Cloud Deployment

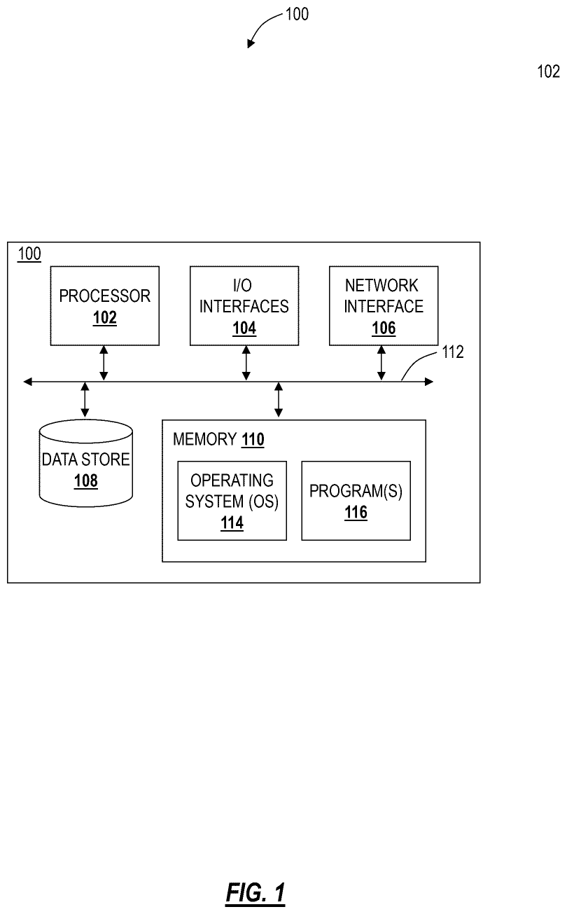

FIG. 1 is a block diagram of a computing system 100 that may be used to implement various components described in this disclosure. The computing system 100 can be implemented in many forms, including laptops, desktops, smartphones, tablets, physical servers, clusters of machines, virtual machines (VMs) running on hypervisors, or serverless computing frameworks. Regardless of the underlying infrastructure, the computing system 100 typically includes one or more processors 102, input/output (I/O) interfaces 104, a network interface 106, a data store 108, and memory 110. Note that FIG. 1 provides a simplified representation; in practice, the computing system 100 may include additional hardware and software elements. These components 102, 104, 106, 108, 110 are connected via a local interface 112, which can include various wired or wireless buses, high-speed interconnects, or switching fabrics. The local interface 112 may also include controllers, buffers, caches, drivers, repeaters, and receivers, along with addressing and control lines that facilitate efficient communication and resource sharing among components.

Each processor 102 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 102 retrieves and executes instructions stored in memory 110, manages data exchanges with the data store 108, and oversees system 100 operations. In large-scale environments, multiple processors 102 may operate in parallel to handle elevated traffic and complex workloads.

The I/O interfaces 104 enable the computing system 100 to interact with external peripherals, allowing user input (e.g., via keyboards, touchscreens, or sensors) and system output (e.g., to displays or printers). Depending on the application, these I/O interfaces 104 may also support specialized devices used for maintenance, debugging, or other administrative functions. Meanwhile, the network interface 106 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 106 can remain protected, enabling the computing system 100 to participate safely in distributed or cloud-based deployments.

The data store 108 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 108 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 108 can hold operational logs, configuration details, policy rules, program binaries, and cached computation results.

The memory 110 typically serves as the primary working memory for the processors 102. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 110 can be distributed across nodes or servers to support the large-scale in-memory processing demanded by modern cloud services. Generally, the memory 110 stores the operating system (O/S) 114 and one or more programs 116. The O/S 114 handles core system tasks such as process scheduling, memory allocation, file management, and networking.

For Software-as-a-Service (SaaS) or other cloud-based components, the computing system 100 can be deployed in various ways: as a private cloud in a single organization's datacenter, a public cloud hosted by a third-party provider, or a hybrid cloud that combines both approaches for specific security, performance, or compliance considerations. Cloud computing abstracts physical hardware—servers, storage devices, and networks—into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### Automated Threat Analysis and Detection

The systems and methods described herein pertain to a cutting-edge cybersecurity threat detection system specifically designed to automate the monitoring and analysis of system logs generated within tenant environments. These logs capture critical information about system activities, including process execution, network interactions, and changes to files, which are key indicators of potential security breaches or malicious activities. The system goes beyond traditional log analysis by integrating these system logs with cloud nano log data to create a comprehensive dataset for advanced threat detection. It employs a generative Artificial Intelligence (AI) model powered by a Retrieval-Augmented Generation (RAG) framework to proactively identify potential cybersecurity threats.

A core innovation of the system is its reliance on dynamic intelligence updates facilitated by a live crawler. This crawler continuously gathers the latest threat intelligence by accessing publicly available and reputable threat data sources, such as AWS GuardDuty findings, Falco rules, Common Vulnerabilities and Exposures (CVE) databases, and the like. The collected threat intelligence is then structured and stored in a high-performance vector store using a semantic chunking strategy. Semantic chunking breaks the data into meaningful and manageable units, allowing the generative AI model to efficiently retrieve and correlate information for threat analysis. This enables the system to dynamically adapt to the ever-changing landscape of cybersecurity threats.

By utilizing a generative AI model and the RAG framework, the system eliminates the need for manual interpretation and coding typically associated with rule-based or signature-based threat detection systems. Traditional systems require human engineers to painstakingly develop and update detection rules for each new vulnerability or attack pattern, a process that is time-consuming, prone to human error, and lacks scalability. In contrast, the generative AI in this invention automatically adapts to new threats and updates its detection logic in real time by leveraging the continuously refreshed data in the RAG system. This approach represents a paradigm shift in threat detection, enabling automated, real-time identification of anomalies and threats without direct human intervention.

As a result, this invention delivers significant improvements in accuracy, scalability, and efficiency for identifying and mitigating cybersecurity threats. Its ability to process and analyze large volumes of system logs while dynamically incorporating the latest threat intelligence allows organizations to stay ahead of emerging risks. The system not only reduces dependency on human expertise but also accelerates response times to potential threats, making it an essential tool for securing Linux-based systems against sophisticated and evolving cyberattacks.

RAG is an advanced framework that combines retrieval-based methods with generative AI models to enable dynamic and intelligent information processing. At its core, RAG merges two essential components: a retrieval module, which queries a knowledge base or external data sources for relevant information, and a generative AI module, such as a Large Language Model (LLM), which synthesizes insights or responses by leveraging the retrieved data. This approach allows RAG systems to operate beyond the constraints of static, pre-trained models by accessing and integrating real-time, contextually relevant information. In essence, RAG bridges the gap between static AI models and dynamic, data-driven intelligence needs, making it ideal for applications such as cybersecurity, where real-time adaptability and decision-making are critical. The RAG framework's retrieval module relies on a database or repository containing structured or unstructured data, which is indexed for efficient semantic querying. When tasked with analyzing input, the system retrieves the most relevant data segments and processes them through the generative AI model. Rather than relying solely on pre-existing knowledge encoded during training, the system augments its reasoning with up-to-date, context-aware data, making it far more dynamic and effective for real-time responses. The framework also incorporates mechanisms for continuous updates, ensuring that its knowledge base remains current as new information becomes available.

In the context of cybersecurity threat detection, RAG plays a pivotal role in automating the identification of threats by dynamically correlating system logs, behavioral anomalies, and real-time threat intelligence. The present RAG framework forms the backbone of the system by integrating a continuously updated vector store, which is populated with both internal system logs (such as process activities, network interactions, and file changes) and external threat intelligence from trusted sources. This vector store uses semantic chunking, a method that divides large datasets into meaningful, manageable chunks for efficient indexing and retrieval. This ensures that the retrieval module can quickly identify relevant information when analyzing inputs such as system events related to tenant environments. The system employs a live data crawler to update the vector store in near real-time, continuously gathering information about new vulnerabilities, malware signatures, attack patterns, and other critical updates from public and private threat intelligence feeds.

When the system receives logs or events for analysis, the RAG retrieval module activates to query the vector store for relevant threat intelligence. For example, if network interactions or file changes within the system resemble known attack behaviors outlined in Falco or CVE data, the retrieval module surfaces these connections. Once relevant data is retrieved, the generative AI model analyzes it alongside the newly ingested system logs, correlating patterns, and computing anomaly scores using advanced techniques like Term Frequency-Inverse Document Frequency (TF-IDF). The generative AI component contextualizes and synthesizes these findings, providing nuanced insights into whether an event constitutes a potential threat. By comparing the anomaly score to a predefined threshold, the system determines if there is a threat requiring action. If the threshold is exceeded, an alert is generated and forwarded to a threat detection engine for further response. If the score remains below the threshold, the system sends a “no alert” status, indicating normal activity.

In parallel to active detection, the RAG framework functions as a background engine, continuously refining its knowledge base. The live data crawler feeds new information into the vector store, and relevant data is dynamically re-indexed to ensure the most up-to-date threat intelligence is available for future queries. This approach allows the system to adapt in real time, detecting threats that rely on emerging techniques or exploiting newly discovered vulnerabilities. Unlike static, rule-based methods, RAG eliminates the need for human engineers to manually create or update detection rules, achieving superior adaptability and reducing false positives. Furthermore, the integration of live intelligence enables the detection of zero-day attacks, novel malware, and evolving threats that might otherwise evade static detection methods. By fusing the strengths of retrieval and generative AI, the RAG framework transforms cybersecurity systems into dynamic, scalable, and highly efficient tools capable of protecting against a constantly shifting threat landscape.

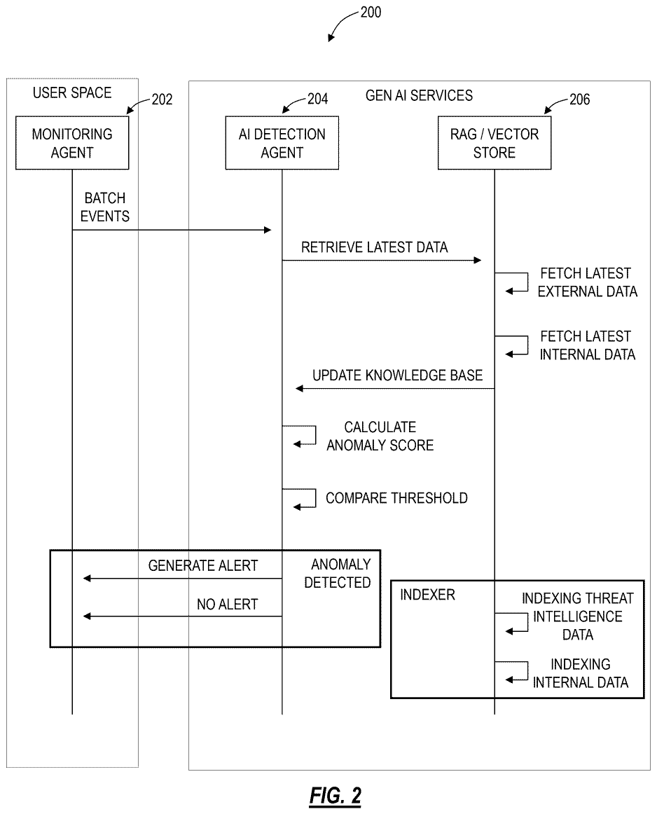

FIG. 2 is a flow diagram illustrating a workflow of an automated cybersecurity threat detection system. This figure illustrates the workflow of an automated cybersecurity threat detection system 200 that integrates monitoring, anomaly detection, and dynamic knowledge updates using a RAG system 206/vector store. The automated cybersecurity threat detection system 200 includes three main components: the monitoring agent 202 in the user space, the AI Detection Agent (AID) 204 using generative AI, and the RAG system 206/vector store, which serves as the dynamic repository of threat intelligence data. The workflow begins with the monitoring agent 202 gathering batch events from the cloud-based system 120 associated with a tenant, such as logs related to process activities, network interactions, and file changes. This data is sent to the AI detection agent 204 via the function “applyAIDetection( )”, which initiates the threat detection process. Once the events are received, the AI detection agent 204 retrieves the latest threat intelligence data by querying the RAG system 206 through a “retrieveLatestData( )” function. Here, the RAG system 206 provides external threat intelligence (e.g., updates from CVEs, AWS GuardDuty findings, Falco rules, etc.) via a “fetchThreatIntelligenceData( )” function and internal resources via a “fetchInternalResources( )” function. The retrieved data is then used to update the AI detection agent's knowledge base through an “updateKnowledgeBase( )” function, ensuring that the latest intelligence is included for anomaly detection.

After updating its knowledge base, the AI detection agent 204 calculates an anomaly score to assess the likelihood that the events indicate a cybersecurity threat. This is achieved using methods such as Term Frequency-Inverse Document Frequency (TF-IDF) and other threat detection systems/methods of the cloud 120. The calculated anomaly score is compared to a predefined threshold, which determines whether the analyzed events are indicative of potential threats. If the score exceeds the threshold, the AI detection agent 204 generates an alert and sends it to a threat detection engine for further action. Conversely, if the score falls below the threshold, the AI detection agent 204 sends a “no alert” signal to indicate that no abnormalities were detected.

In the background, the RAG system 206/vector store continuously ensures the system remains updated and efficient. It performs dynamic indexing of external threat data and internal resources whenever changes are detected in the data. Threat intelligence, including updates to CVEs, AWS GuardDuty findings, Falco rules, etc., is indexed alongside internal organizational logs using semantic chunking for efficient retrieval. Additionally, a live data crawler is employed to scan external sources in real-time, keeping the vector store populated with the latest threat intelligence. This comprehensive indexing ensures that the AI detection agent 204 always has access to the most current and relevant information when performing its analyses.

Through its integration of dynamic retrieval and generative intelligence, the system moves away from traditional static, rule-based detection methods. Instead, it achieves real-time, automated threat detection that eliminates manual interventions while providing enhanced scalability, accuracy, and responsiveness. By combining monitoring, AI-driven decision-making, and dynamic intelligence updates, this system provides an innovative solution for identifying and mitigating cybersecurity threats in complex environments.

In an example use case, a new zero-day vulnerability, CVE-2025-XXXX, is discovered and publicly disclosed in a security database. Attackers are already exploiting this vulnerability to gain unauthorized access to systems. The live crawler of the present cybersecurity threat detection system continuously scans threat intelligence sources, including the CVE database, AWS GuardDuty, Falco rules, etc., for new updates. Upon detecting the new CVE entry, the crawler extracts relevant information such as the attack vector, affected systems, and recommended mitigations. It then processes this data using semantic chunking, breaking it into meaningful segments before storing it in the high-performance vector store for efficient retrieval.

Once the new threat intelligence is stored, the (RAG) system ensures that it is immediately available for use in threat detection. When a tenant system generates logs indicating suspicious activity, such as unusual process execution, unauthorized network requests, or modifications to sensitive files, the AI detection agent 204 queries the vector store for relevant threat intelligence. The retrieval process locates the newly ingested CVE information and supplies it to the generative AI model for analysis. The AI then correlates the system logs with the new threat data, assessing whether the behavior matches the attack patterns described in the CVE.

Using anomaly detection techniques, the AI assigns an anomaly score to the event. If the score surpasses a predefined threshold, an alert is triggered and forwarded to the threat detection engine for further investigation. The system may recommend actions such as isolating the affected host or applying security patches. Meanwhile, if the activity does not meet the threat criteria, the system logs a “no alert” status, avoiding unnecessary false positives.

In parallel, the live crawler continues monitoring external threat intelligence feeds, ensuring that the RAG system remains up to date. If additional attack signatures or new mitigations are published for CVE-2025-XXXX, the crawler retrieves and updates the vector store with this information. This continuous cycle allows the cybersecurity system to proactively adapt to evolving threats without requiring manual intervention, making it highly effective in detecting zero-day exploits, advanced malware, and evolving attack techniques.

### Process for Automated Threat Analysis and Detection

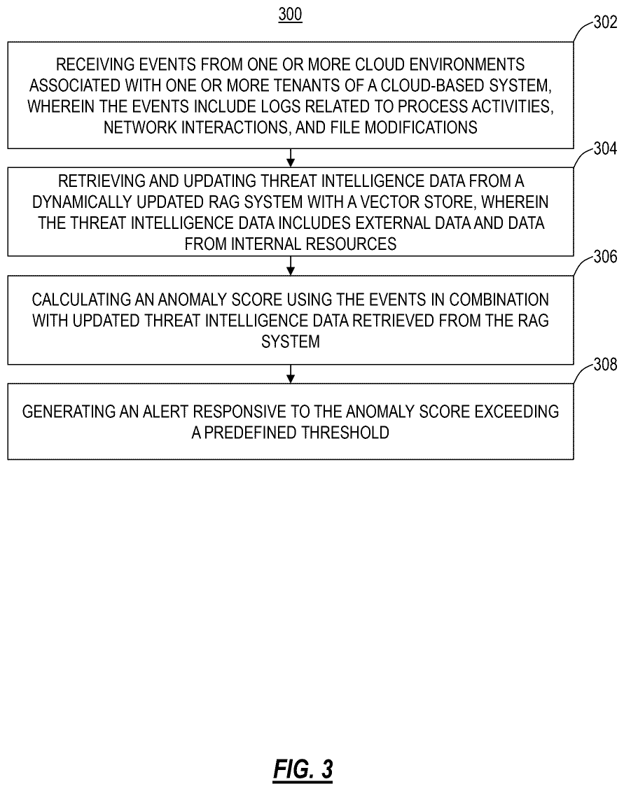

FIG. 3 is a flowchart of a process 300 for automated threat analysis and detection. In various embodiments, the process 300 can be implemented in multiple ways: as a method comprising distinct steps, via the computing system 100 configured to execute those steps, via a cloud system configured to do so, or through a non-transitory computer-readable medium that stores instructions causing one or more processors to perform the steps. This flexibility allows process 300 to be adapted to various system architectures and deployment scenarios.

In various embodiments, process 300 includes receiving events from one or more cloud environments associated with one or more tenants of a cloud-based system, wherein the events include logs related to process activities, network interactions, and file modifications (step 302); retrieving and updating threat intelligence data from a dynamically updated RAG system with a vector store, wherein the threat intelligence data includes external data and data from internal resources (step 304); calculating an anomaly score using the events in combination with updated threat intelligence data retrieved from the RAG system (step 306); and generating an alert responsive to the anomaly score exceeding a predefined threshold (step 308).

The process 300 can further include wherein the external data includes Common Vulnerabilities and Exposures (CVEs) and data from threat databases. The calculating can be performed using Term Frequency-Inverse Document Frequency (TF-IDF). The steps can include sending a “no alert” message if the anomaly score is below the predefined threshold. Retrieving threat intelligence data can include dynamically accessing external resources through a live data crawler that continuously updates the vector store. Retrieving threat intelligence data can include semantic chunking of threat intelligence data, dividing the data into meaningful units for efficient indexing and querying. Calculating the anomaly score can further incorporate patterns of network traffic detected in the events that resemble known command-and-control activity. The predefined threshold can be dynamically adjustable based on user-specific configurations or historical anomaly patterns. The steps can include continuously scanning threat intelligence sources via a live crawler. The events can be received from a monitoring agent within a user space.

### Automated CVE Enrichment and Vulnerability Analysis

Traditional vulnerability management systems often fall short in delivering a comprehensive understanding of security vulnerabilities. These systems typically rely on basic data points, such as simple textual descriptions and CVSS scores, which provide only a surface-level view of Common Vulnerability and Exposures (CVEs). As a result, security analysts are forced to manually research and correlate disparate information from multiple sources to gain a deeper understanding of vulnerabilities. This approach is not only time-consuming but highly inconsistent, often leading to incomplete assessments and leaving organizations exposed to potential security risks. To address these critical limitations, the present systems introduce a system for automated CVE enrichment and vulnerability analysis, also referred to as “GenCVE”. Various embodiments include an innovative solution that automatically generates enriched attributes for CVEs, transforming how vulnerabilities are analyzed and understood. By using information from the National Vulnerability Database (NVD) and leveraging the provided CVE descriptions as input, GenCVE generates a plurality of additional attributes that add significant depth to vulnerability analysis. This process is further enhanced by integrating the MITRE Adversarial Tactics, Techniques, and Common Knowledge (ATT&CK) framework, which maps probable and possible attacker tactics and techniques to vulnerabilities, complete with justifications. Unlike traditional systems, GenCVE offers enriched attributes, including technical context, detailed attack surface analysis, and practical mitigation strategies, all without requiring manual intervention. Current solutions lack the capability to seamlessly integrate tactical frameworks like MITRE ATT&CK into CVE descriptions or provide nuanced, multi-level explanations tailored to both entry-level and expert analysts. The manual effort required to gather, interpret, and connect vulnerability information from various sources creates operational inefficiencies, increases the risk of human error, and leaves critical gaps in security understanding. GenCVE effectively closes these gaps, offering a streamlined, automated approach that empowers security teams to make quicker, more informed decisions and significantly enhances organizational resilience against cyber threats.

The invention introduces a groundbreaking automated CVE enrichment system designed to revolutionize vulnerability management by converting basic CVE data into comprehensive security intelligence. Leveraging advanced technologies such as Large Language Models (LLMs) and multi-source integration, this system processes raw CVE descriptions and corresponding MITRE ATT&CK mappings to yield highly structured, actionable insights. The output can be delivered in the form of a JSON object containing key components that address critical aspects of vulnerability analysis. These components include enhanced publication details enriched with metadata and advanced scoring metrics; a clear and concise vulnerability overview that outlines affected software versions and potential upgrade paths; and multi-level examples that cater to both technical and non-technical audiences, providing accessible explanations and use cases. Additionally, the system performs detailed exploitation analysis, offering insights into how vulnerabilities can be exploited, while conducting an exhaustive attack surface evaluation paired with tailored defense strategies. Integration with the MITRE ATT&CK framework ensures alignment with tactical perspectives, including a detailed exploration of attacker techniques mapped directly to CVE data. Curated external references further enhance the breadth and reliability of the information provided.

To achieve this sophisticated output, the system harnesses the power of LLMs, enabling intelligent and context-aware analysis generation. It integrates seamlessly with the NVD to ensure the data is both authoritative and up-to-date, while leveraging the Tavily API for comprehensive aggregation of external references. Through advanced prompt engineering, the system ensures consistent and accurate results, generating over 40 enriched attributes that deliver deep technical context, attack scenarios, mitigation recommendations, and practical implementation guidance. Quality control is embedded in the process through automatic validation mechanisms, reference deduplication, and structured formatting, which collectively maintain the reliability and precision of the output across diverse types of vulnerabilities. By automating what was traditionally a manual and error-prone process, the invention empowers security practitioners with high-quality, ready-to-use intelligence, significantly enhancing their ability to understand, address, and mitigate vulnerabilities effectively across all operational layers.

The present systems are designed to generate various core components that provide a comprehensive approach to analyzing and understanding vulnerabilities. Each component has been carefully developed to address critical aspects of vulnerability management, significantly enhancing the depth, clarity, and actionability of the information provided. The first component, Publication Information, generates enhanced CVE metadata that goes beyond basic identifiers. This includes detailed publication details enriched with additional contextual data, ensuring that users have access to all crucial information regarding a vulnerability's origin, timeline, and associated scoring metrics for prioritization purposes.

Next is the Overview, wherein the systems create clear and concise descriptions of vulnerabilities. These descriptions distill technical jargon into straightforward language while maintaining accuracy, offering a summary that is accessible to both technical and non-technical audiences. This is complemented by the Quick Example component, which generates practical explanations of the vulnerabilities. These examples illustrate real-world scenarios and use cases, bridging the gap between abstract technical details and tangible understanding, thereby aiding various users, from security analysts to decision-makers, in grasping the implications of a vulnerability.

The systems further delve into the intricacies of vulnerabilities through the CVE Exploitation component, which provides detailed analyses of how a vulnerability could be exploited. This includes insights into potential attack vectors, methods employed by attackers, and the consequences of successful exploitation. Paired with this is the Attack Surface Analysis component, which evaluates the potential entry points vulnerable to exploitation and generates corresponding defense strategies. This analysis equips security teams with actionable recommendations to minimize risk and strengthen organizational defenses.

To align vulnerability insights with tactical cybersecurity frameworks, the systems offer MITRE ATT&CK Mapping, where vulnerabilities are mapped to likely attacker tactics and techniques based on the widely recognized MITRE ATT&CK framework. This mapping ensures tactical alignment and gives analysts a structured understanding of how vulnerabilities fit into broader attack scenarios. Expanding further, the MITRE ATT&CK Analysis component provides detailed investigation into specific attack techniques linked to the vulnerability. This includes justifications and practical insights into how these techniques could be leveraged by threat actors in the real world, helping teams devise more informed countermeasures.

Finally, the systems generate External References, which aggregate curated, relevant sources of information from authoritative and reliable channels. These references can include advisories, research papers, blogs, or other resources that offer additional context, ensuring that users can validate findings and explore further details as needed. Collectively, these components form an integrated system that automates the transformation of raw CVE data into actionable, multi-dimensional security intelligence. By combining metadata, practical scenarios, exploitation analyses, defense strategies, tactical insights, and curated references, the systems empower security teams to make faster, more informed decisions while significantly improving the efficiency and effectiveness of vulnerability management workflows.

The present invention introduces several core innovations that fundamentally transform the way vulnerabilities are analyzed, understood, and managed, delivering groundbreaking advancements in efficiency, accuracy, and comprehensiveness. At the heart of the invention is its capability for automated attribute generation, which transforms a single CVE description into over 40 enriched attributes. This automated process eliminates the need for time-intensive manual research by generating human-readable technical analyses that are both detailed and accessible. These enriched attributes include structured data on exploitation scenarios and mitigation strategies, catering to diverse analytical needs across technical, tactical, and strategic perspectives. By presenting a comprehensive view of vulnerabilities tailored to various expertise levels, this feature empowers security teams to quickly and effectively assess and prioritize risks.

Another key innovation is the system's Intelligent MITRE ATT&CK integration, which seamlessly incorporates the widely used MITRE ATT&CK framework into the vulnerability analysis process. This integration maps vulnerabilities to their probable and possible attack techniques, providing detailed insight into attacker behaviors and tactics. In addition, the system conducts in-depth analysis of attack paths, offering precise technique justifications that help validate the mappings. To further enhance usability, the invention generates attack flow visualizations, presenting complex relationships between vulnerabilities and potential attacker tactics in an intuitive format. This visualization facilitates a deeper understanding of how vulnerabilities may be exploited in real-world scenarios, enabling teams to anticipate and disrupt adversarial actions more effectively.

The system's ability to synthesize information from multiple sources represents a significant leap forward in vulnerability intelligence. This multi-source intelligence fusion combines official data from the NVD with insights from the MITRE ATT&CK framework, ensuring that analysis is both authoritative and contextually rich. Additionally, the system integrates data from the Tavily API to aggregate references from a wide range of sources, including security blogs, advisories, and industry reports. By consolidating intelligence from these diverse inputs, the invention ensures a holistic understanding of vulnerabilities, eliminating information silos and enabling security teams to make data-driven decisions with confidence.

Finally, the invention is designed to empower security experts through enhanced efficiency and analytical precision. This security expert enablement capability reduces vulnerability analysis time from hours to minutes, freeing up resources and allowing teams to focus on proactive threat mitigation rather than laborious manual research. The structure and clarity of the output deliver a standardized understanding of vulnerabilities, which improves cross-team communication and collaboration. By providing actionable insights and streamlining decision-making processes, the invention transforms vulnerability assessments into a faster, more reliable, and highly scalable operation.

Together, these core innovations combine to create a powerful, automated, and intelligent system that redefines traditional vulnerability management. By automating attribute generation, integrating tactical frameworks, fusing intelligence from multiple sources, and directly empowering security professionals, this invention ensures that organizations can respond to vulnerabilities with unprecedented speed, precision, and effectiveness.

### Automated CVE Enrichment Example

The example provided illustrates how the present systems process an input containing CVE basic information and associated MITRE ATT&CK mappings to generate enriched, actionable security intelligence. The input begins with the CVE Basic Information, where, for this example, the CVE in focus is identified as “CVE-2020-14183.” This CVE highlights an Information Disclosure vulnerability in Jira Server & Data Center that allows a remote attacker with limited privileges (non-administrative) to view the system's Support Entitlement Number (SEN) via specific HTTP response headers. The vulnerability affects several Jira versions: those prior to version 7.13.18, versions 8.0.0 through 8.5.9, and versions 8.6.0 through 8.12.1. This input text provides a clear groundwork for the system to perform further analysis, extracting key details like the affected software versions, the nature of the vulnerability, and the conditions under which it can be exploited.

In addition to the CVE details, the system processes the associated MITRE ATT&CK Mapping Structure, which elucidates the attacker behaviors and tactics potentially relevant to this vulnerability. The system splits attacker behaviors into probable and possible tactics, providing structured insights into how adversaries might exploit the vulnerability to achieve specific goals. Within the probable section, two tactics are outlined:
Initial Access (TA0001): The “Valid Accounts” technique (T1078) is mapped here, with justification explaining that exploitation of the vulnerability requires non-admin, valid credentials, underscoring the attacker's need for an authenticated session to initiate the attack.
Collection (TA0009): The “Data from Local System” technique (T1005) is cited, explaining that the vulnerability enables attackers to collect the SEN by examining the HTTP response headers, thus achieving data collection that could be leveraged for further exploitation or lateral movement.

The possible section identifies an additional tactic:
Exfiltration (TA0010): The “Automated Exfiltration” technique (T1020) suggests that attackers could automate the extraction of the disclosed SEN, making it feasible to scale the attack or exfiltrate sensitive data in an efficient manner. This speculative mapping extends the analysis to cover how attackers might expand their activity once they have collected the disclosed information.

This structured input demonstrates how the system takes raw vulnerability data and contextualized attacker behaviors to perform a comprehensive evaluation. The CVE details and MITRE ATT&CK mappings serve as foundational inputs for the system to generate enriched attributes such as affected software versions, attack scenarios, technical justifications, and mitigation strategies. By leveraging this input data, the present systems are capable of performing multi-dimensional analysis, producing outputs that include actionable intelligence like exploitation paths, defense strategies, and high-value insights tailored to security teams' needs. This automated process ultimately enhances organizational security by streamlining the assessment and prioritization of vulnerabilities, aligning vulnerability details with tactical frameworks, and offering a holistic view of potential threats and mitigations.

The Publication Information component, generated by the present systems based on the provided input, consolidates essential metadata, security metrics, and authoritative references to provide a clear, structured, and comprehensive overview of the analyzed vulnerability, CVE-2020-14183. This component draws on multiple sources, ensuring authoritative data, enriched context, and actionable intelligence to assist security teams in vulnerability assessment and remediation processes.

The component begins with temporal details, including the published date (2020-10-06) and the last-modified timestamp (2024-11-21), allowing users to track the evolution of the CVE's lifecycle. By including a reference to the NIST NVD entry and Atlassian's vendor-specific advisory page, the system ensures that the metadata is sourced directly from reliable and trusted sources.

The component provides comprehensive enrichment data, starting with the classification of the vulnerability under the Common Weakness Enumeration (CWE), specifically CWE-200 (“Exposure of Sensitive Information”). This linking enables in-depth exploration of the general security issue category referenced by the CVE, helping users understand its broader implications and remediation approaches.

The component also aggregates and generates a robust set of references that span multiple reputable sources. For example, curated entries are included from platforms such as OpenCVE, Tenable, Rapid7, Vumetric, and CySecurity, in addition to Atlassian's advisories. Each reference is annotated with tags such as “Permissions Required” and “Vendor Advisory” or marked with “tavily_search,” which indicates data collected via external API-based aggregation systems like Tavily. This aggregation ensures that users have access to a diverse set of resources for further exploration and validation of the vulnerability, addressing varying organizational needs.

One of the key features of this component is its ability to present comprehensive CVSS scoring across version 3.1 and version 2.0 standards. CVSS v3.1 metadata reveals that the vulnerability is classified as “Medium” with a base score of 4.3, denoting moderate risk based on low attack complexity, limited privileges required, and unchanged scope. Granular attributes such as the attack vector (Network), confidentiality impact (Low), and exploitability score (2.8) provide a detailed technical breakdown of how the vulnerability operates and affects systems. Similarly, the system generates CVSS v2.0 metrics to aid organizations still relying on legacy scoring systems. Attributes include an access vector of Network, authentication level (Single), and confidentiality impact (Partial), with a slightly different base score of 4.0. Both versions incorporate nuanced details that allow organizations to tailor their risk evaluations based on technical environments, stakeholders, and legacy security frameworks.

To provide actionable insights, the system identifies primary and additional advisories, including Atlassian's vendor advisory and related resources with easy-to-access links. Security teams can leverage these consolidated advisories to follow up directly with vendors for patches, configuration changes, or additional mitigation recommendations.

The enrichment process enables consistent and structured reporting of technical metrics. Critical elements such as the required privileges (Low) and the absence of user interaction requirements (None) emphasize the ease of exploitation, even for attackers with limited access. These insights are paired with the vulnerability's minimal impact scope (Confidentiality Impact—Low; Integrity Impact—None; Availability Impact—None), highlighting how the disclosed information presents partial risk but may not have overarching consequences unless exploited in combination with other vectors.

The Overview component generated by the present systems provides a concise yet comprehensive summary of the analyzed vulnerability, offering key contextual details such as the scope, impact, affected systems, and remediation guidance. Using the example input for CVE-2020-14183, the generated overview simplifies the complexity of the vulnerability while delivering actionable information for security teams, technical users, and organizations at large.

The component begins with a title that succinctly summarizes the issue: “Jira Server & Data Center Support Entitlement Number (SEN) Information Disclosure.” This title emphasizes the affected platform (Atlassian Jira Server & Data Center), the nature of the vulnerability (Information Disclosure), and the specific sensitive data at risk (Support Entitlement Number or SEN). By framing the title in a clear and straightforward manner, the component ensures immediate understanding of the type of vulnerability being analyzed.

The description elaborates on the vulnerability, highlighting its technical and practical aspects. It identifies that authenticated users with non-admin privileges can exploit this vulnerability to access sensitive licensing information embedded within HTTP response headers. This description communicates the potential security risk posed to organizations using affected Jira versions, focusing on how seemingly minor permissions (non-administrative) can still be leveraged for sensitive data exposure, underscoring the exploitability of the vulnerability.

A dedicated affected versions section provides a detailed breakdown of the vulnerable products and applicable versions, including their vendor information. For example, the vulnerable software is identified as “Jira Server & Data Center,” developed by Atlassian. The start version, “All versions,” highlights that any prior version is susceptible to exploitation unless specifically patched. The end version, “8.12.1,” indicates the last affected release, with versions after 8.12.1 being secure.

To ensure proper remediation, the component further includes affected version elaboration, offering actionable guidance tailored to specific branches and installations. It advises users to: Upgrade to version 7.13.18 for installations running versions below 7.x. Upgrade to version 8.5.9 for versions between 8.0.0 and 8.5.x. Upgrade to version 8.12.1 for installations running versions from 8.6.0 to 8.12.0. This elaboration provides clarity on upgrade paths, ensuring compatibility with existing installations while resolving the vulnerability. It ensures organizations can immediately act upon the guidance without introducing operational disruptions or manual guesswork about patching strategies.

The vulnerability is categorized under the information disclosure type, emphasizing its core nature, the exposure of sensitive data that was intended to remain private. By explicitly defining the vulnerability type, the component facilitates alignment with broader security strategies, such as risk categorization, compliance tracking, and regulatory requirements (e.g., data privacy laws).

The Quick Example component generated by the present systems offers a practical and accessible understanding of the vulnerability for users across varying technical expertise levels. Designed to bridge the gap between abstract vulnerability descriptions and real-world scenarios, this component focuses on delivering insights in simple language, complemented by technical details and step-by-step flows that illustrate the exploitation process. Using the example input for CVE-2020-14183, it integrates intuitive explanations, technical examples, and attacker workflows to simplify the complexity of the vulnerability.

The component begins with a clear, concise title: “SEN Exposure via HTTP Headers.” This title cuts through technical jargon to highlight the core issue, the unauthorized exposure of sensitive licensing information (Support Entitlement Number, SEN) through HTTP response headers.

The explained weakness section identifies the root of the issue, emphasizing the vulnerability's fundamental flaw: authenticated users with basic (non-admin) access can view sensitive licensing information intended only for administrators. This framing establishes the severity and impact of the vulnerability in simple terms, highlighting why organizations should address it urgently.

A straightforward explanation is provided to cater to non-technical audiences: “When a user with basic access rights makes certain requests to the Jira server, the system incorrectly includes the Support Entitlement Number (SEN) in the response headers.” This explanation avoids technical complexity, ensuring clarity for stakeholders who need to understand the problem without specialized technical knowledge.

Taking the simplicity further, the component adds an analogy: “Think of it like a store receipt that accidentally shows the store's confidential business ID number to every customer, instead of keeping it visible only to store managers.” This relatable comparison leverages everyday concepts to illustrate the risk posed by the vulnerability, helping business and legal teams grasp its significance in non-technical contexts.

The technical examples section shifts the focus to security analysts and engineers by providing detailed technical context. It starts with a description: “HTTP Response Header Information Disclosure,” followed by an elaborated_example_code that simulates the vulnerability's output.

To contextualize the attack process, a MITRE attack flow visualizes the steps a threat actor might follow to exploit this vulnerability:
Attacker obtains valid user credentials—The attacker logs in as a basic authenticated user (non-admin).
Attacker makes HTTP requests to the Jira server—Using authorized access, the attacker interacts with Jira's APIs or interfaces.
Attacker examines response headers—By inspecting the headers of HTTP responses, the attacker identifies sensitive data such as the SEN.
Attacker extracts SEN information—The attacker retrieves the SEN, which can be misused for fraudulent purposes or identifying system targets.

This breakdown further aligns the exploitation process with the MITRE ATT&CK framework, combining security-centric perspective with usability. Security teams can use this flow to pinpoint weakness points within their systems and preemptively implement controls or monitoring strategies that disrupt critical stages of the attacker's workflow.

The CVE Exploitation component generated by the present systems offers a focused examination of how the vulnerability can be exploited, clearly outlining the conditions, difficulty level, and scope of exploitation. This component is a vital part of the overall analysis as it translates the technical mechanics of exploitation into actionable intelligence for security teams. Using the example of CVE-2020-14183, it provides a structured breakdown of exploitation risk factors, making it easier for organizations to assess the likelihood of attack and prioritize remediation.

An exploitation explanation provides a succinct yet informative description of how attackers can exploit this vulnerability. In the case of CVE-2020-14183, the component notes: “The vulnerability can be exploited by making authenticated HTTP requests and examining response headers.” This explanation highlights the specific actions an attacker needs to undertake and the targeted weakness within the system. For security teams, this clear description pinpoints the vulnerability's procedural exploit, equipping them to monitor and mitigate such activities effectively.

An exploitation level is categorized as requiring “Low technical expertise,” signifying that attackers do not need advanced skills or tools to take advantage of this vulnerability. It simply involves examining HTTP headers, a common task within web security testing and general web development practices. This ease of exploitation lowers the barrier for potential threat actors, indicating that this vulnerability could be leveraged by a wide range of attackers, from beginners to experienced adversaries.

An exploitation rank is rated as “Easy,” reinforcing the notion that the exploitability of this vulnerability is straightforward. Unlike more complex vulnerabilities that require chaining multiple conditions or leveraging sophisticated techniques, this issue can be exploited with minimal effort by an attacker possessing valid credentials. This high rank underscores the importance of patching or mitigating this vulnerability promptly, as ease of exploitation increases its potential for abuse.

An exploitation severity is marked as “Medium” to reflect the nature and impact of exploitation. While the vulnerability allows an attacker to access sensitive licensing information (SEN), it does not directly compromise critical system functionalities such as database access, file permissions, or user accounts. However, the disclosed information could serve as a steppingstone for follow-up attacks, such as phishing, fraud, or reconnaissance, which justifies the medium severity rating. Security teams are therefore advised to consider this vulnerability's potential implications as part of a broader threat landscape.

The exploitation popularity is rated as “Low to Medium,” depending on the scope of the vulnerability's impact. Because it requires valid credentials, the popularity of exploitation remains lower compared to unauthenticated vulnerabilities. However, the popularity could increase if attackers identify creative ways to use the disclosed SEN for follow-on attacks, or if the information becomes useful in specific threat campaigns. By including this rating, the system contextualizes how likely the vulnerability is to be leveraged by attackers in real-world scenarios.

The Attack Surface Analysis component generated by the present systems offers a comprehensive examination of how a vulnerability interacts with an affected system, including the components it exposes and actionable strategies to mitigate associated risks. This component provides organizations with the tools to evaluate entry points for attacks, identify areas of impact, and implement both immediate and long-term defense mechanisms. Using the example of CVE-2020-14183, the analysis serves as a detailed blueprint for vulnerability management and security reinforcement, enabling teams to prioritize corrective actions effectively.

The analysis begins with the attack vector, which describes the nature of the vulnerability's exploitation mechanism, simplifying the process for security teams to develop defense strategies. In the case of CVE-2020-14183, exploitation is classified as a network-based attack vector, indicating remote accessibility. The vulnerability manifests through HTTP response headers that inadvertently expose sensitive licensing information, specifically the Support Entitlement Number (SEN). Exploiting this vulnerability requires valid user credentials, making authentication a prerequisite, yet it remains accessible to users with only regular user privileges, emphasizing its potential for misuse by insiders or compromised accounts. This low access threshold underscores the risk posed to organizational security and highlights the need for urgent remediation.

The attack surface analysis expands on the exposed system components and areas of potential impact. For CVE-2020-14183, two critical components are identified: HTTP response headers, through which the SEN is disclosed, and the License Management System, which is indirectly exposed due to the leaked licensing information. These vulnerabilities can lead to cascading risks across several impact areas. For instance, unauthorized access to licensing information could be exploited for fraud or to manipulate licensing metadata. Additionally, attackers might misuse SEN data to gain undue access to systems or impersonate legitimate customers in the support system. Moreover, the exposure of licensing details risks compromising the organization's identity, leaving it open to reconnaissance, phishing campaigns, or other forms of exploitation by cybercriminals. This thorough breakdown illustrates the reach of the vulnerability within internal systems and external interactions, providing clarity on where protective measures should be focused.

The defense strategy section delivers a structured plan to mitigate risks stemming from the vulnerability. It begins with immediate actions designed to reduce exploitation risks promptly. These steps include upgrading to the latest patched version of Jira to resolve the vulnerability, monitoring HTTP requests for suspicious activity targeting sensitive endpoints, and reviewing user access logs for unusual or repeated attempts at accessing exposed data. Beyond these urgent fixes, the strategy proposes architectural improvements to strengthen long-term system resilience. These include implementing header security controls to sanitize outgoing HTTP response data, enhancing privilege separation to restrict access to sensitive information like SEN exclusively to administrative roles, and deploying robust access control mechanisms to enforce least privilege principles and protect credentials. The strategy also emphasizes monitoring recommendations to safeguard against future exploitation, such as inspecting HTTP response headers for sensitive data exposure, tracking anomalous access patterns, and logging attempts to retrieve administrative information, such as SEN, in inappropriate contexts.

The Attack Surface Analysis component plays a crucial role in transforming technical vulnerability details into actionable insights for crafting defensive strategies. It facilitates comprehensive risk understanding by detailing both attack vectors and exposed components, ensuring organizations can visualize how the vulnerability could be exploited and assess its broader impact on systems and processes. The analysis provides categorized defense strategies, dividing mitigation into three key areas: immediate actions for rapid response, architectural improvements for long-term resilience, and monitoring recommendations for continuous vigilance. By focusing on specific areas of impact, such as licensing information or organizational identity, it offers targeted remediation guidance, helping teams prioritize protective measures that yield maximum security benefits. Additionally, the structured presentation eliminates guesswork, enabling security teams to operationalize responses quickly, which is particularly valuable for organizations with limited resources.

The component's practical applications are abundant. Vulnerability management teams can implement permanent controls, such as stricter HTTP header sanitization policies, based on insights from the architectural improvement section. Incident response teams can concentrate their monitoring efforts on HTTP response headers and user activity logs to detect exploitation attempts as they occur. Similarly, compliance teams can ensure sensitive licensing data like SEN is adequately protected and aligned with regulatory requirements, minimizing the risk of financial and reputational penalties.

The MITRE ATT&CK Mapping component generated by the present systems provides a structured alignment of vulnerabilities with relevant tactics and techniques from the widely recognized MITRE ATT&CK framework. By categorizing potential attacker behaviors into probable and possible tactics, this component enables organizations to understand how a vulnerability, such as CVE-2020-14183, could be exploited within broader adversarial workflows. This structured approach empowers security teams to anticipate attacker strategies and implement targeted defenses, ensuring a more proactive security posture.

The probable category identifies tactics that are strongly associated with the exploitation of the vulnerability, allowing organizations to prioritize defenses against the most likely attack paths. For CVE-2020-14183, two probable tactics are highlighted. First, Initial Access (TA0001) represents the attacker's effort to establish a foothold in the system. Since exploiting this vulnerability requires authenticated user credentials, it aligns closely with this tactic, where an attacker gains entry to interact with the exposed HTTP response headers. Second, Collection (TA0009) reflects an attacker's capacity to gather sensitive information, such as licensing data. In this case, the vulnerability enables the attacker to extract the SEN from the HTTP response headers, a behavior that fits neatly into this tactic. These probable tactics emphasize tangible, immediate exploitation risks, helping organizations focus on strengthening their defenses.

The possible category outlines follow-up tactics that attackers might employ after initial exploitation, providing insight into longer-term risks. For CVE-2020-14183, the possible tactic identified is Exfiltration (TA0010), which involves the unauthorized transfer of data outside the target organization. While the primary exploit focuses on exposing the SEN via HTTP response headers, there is potential for attackers to automate the exfiltration process or misuse the data for fraud or impersonation. This expanded view highlights how vulnerabilities can serve as a stepping stone for more complex attacks, encouraging organizations to adopt a layered defense strategy.

The MITRE ATT&CK Mapping component offers several key advantages. First, it ensures tactical precision by mapping the CVE to specific ATT&CK strategies, providing actionable insights into the attacker's expected behavior before, during, and after exploitation. This allows teams to address immediate risks while also modeling potential long-term threats. Second, it enhances threat intelligence by embedding the vulnerability within a larger adversarial context, aligning it with behaviors commonly observed in real-world attack campaigns. For instance, understanding that tactics like Initial Access and Collection are probable offers insight into targeted attacks, while the inclusion of Exfiltration sheds light on possible data misuse. Third, it supports streamlined defense planning by categorizing tactics into probable and possible groups, enabling organizations to prioritize remediation efforts. Probable tactics drive immediate actions, such as securing access to the affected system, whereas possible tactics can shape ongoing monitoring and long-term strategy development. Finally, the framework encourages cross-team collaboration by making the vulnerability's implications understandable across a variety of stakeholders. Security operations, incident response teams, and threat analysts can leverage the shared MITRE ATT&CK framework to align their efforts and improve overall readiness.

In summary, the MITRE ATT&CK Mapping component bridges the gap between vulnerability analysis and active defense planning by aligning technical exploit details with strategic threat models. Its ability to contextualize attacker behavior within an established framework ensures that organizations can better understand threats, prioritize defenses, and strengthen collaboration across teams, ultimately enhancing their overall security posture.

The MITRE ATT&CK Analysis component generated by the present systems provides a deeper level of insight into the tactics, techniques, and procedures likely to be employed by attackers exploiting a specific vulnerability. By connecting a CVE, such as CVE-2020-14183, to detailed MITRE ATT&CK tactics and techniques, this component enables organizations to understand attacker workflows, identify critical points of failure, and implement precise mitigations. The analysis is divided into probable and possible categories, creating a structured, actionable framework to support both immediate risk reduction and forward-looking defense strategy.

In the probable category, the analysis identifies the tactics Initial Access and Collection, along with their associated techniques: Valid Accounts (T1078) and Data from Local System (T1005). The component provides a title, “Authenticated Information Disclosure,” and describes how attackers exploit this vulnerability by using valid user credentials to access Jira and collect sensitive information, such as the SEN, from HTTP response headers. To enhance user understanding, related items like User Authentication, HTTP Headers, and Access Control are highlighted as key components involved in this attack flow. Supporting this analysis are direct links to the ATT&CK framework's technical entries for related techniques (e.g., Valid Accounts and Data from Local System), enabling further exploration of the techniques involved. An attack path explanation succinctly summarizes the workflow: “Attacker uses valid credentials to access Jira, makes requests, and collects SEN from headers.” To mitigate these risks, the component suggests practical defenses, including implementing proper access controls, conducting regular security updates, and performing header security reviews to validate that sensitive data is excluded from HTTP responses. These focused recommendations enable organizations to address root causes and reduce the likelihood of successful exploitation.

The possible category explores a more speculative yet plausible scenario: the use of the Exfiltration tactic through the Automated Exfiltration (T1020) technique. In this context, the title “Automated Data Collection” reflects the potential for attackers to further exploit the vulnerability by using automated scripts to repeatedly collect and exfiltrate SEN information across various Jira instances. A description highlights the scalability of such an attack and its implications for expanded data misuse. Related items such as Automated Scripts, Data Collection, and Information Exfiltration are emphasized to stress the systemic risks of automated exploitation, with a corresponding link to the ATT&CK entry for Automated Exfiltration. An attack path explanation outlines how an attacker might develop custom tools to capitalize on this vulnerability by harvesting SEN data from multiple systems or accounts. This analysis serves as a cautionary insight into how vulnerabilities that may seem low-impact in isolation could facilitate large-scale, systemic attacks.

Taken together, this component offers several key benefits. First, it provides in-depth attack simulations by detailing the tactics, techniques, and workflow an attacker would likely employ, enabling organizations to enhance their threat modeling and incident response processes. Second, the inclusion of related items and URLs creates a pathway for security teams to dive deeper into specific techniques, allowing for advanced research and cross-team collaboration. Third, by articulating both probable and possible attack paths, the component ensures organizations can address immediate risks while staying vigilant against potential future threats. Lastly, the inclusion of potential mitigations ensures actionable recommendations accompany the analysis, such as tightening user authentication, implementing robust access controls, conducting regular security reviews, and monitoring systems for signs of automated data exfiltration.

This analysis contributes directly to an organization's ability to operationalize security intelligence. For instance, incident response teams can use the attack paths to simulate adversary workflows and identify chokepoints where defenses can disrupt potential exploitation. Teams can replicate the described attack scenarios as part of vulnerability testing efforts, helping validate existing defenses or uncover additional exposures. Meanwhile, vulnerability management teams can implement the outlined mitigations, ensuring systemic layers of protection are in place, such as access control enhancements to ensure SEN visibility is restricted only to administrative roles.

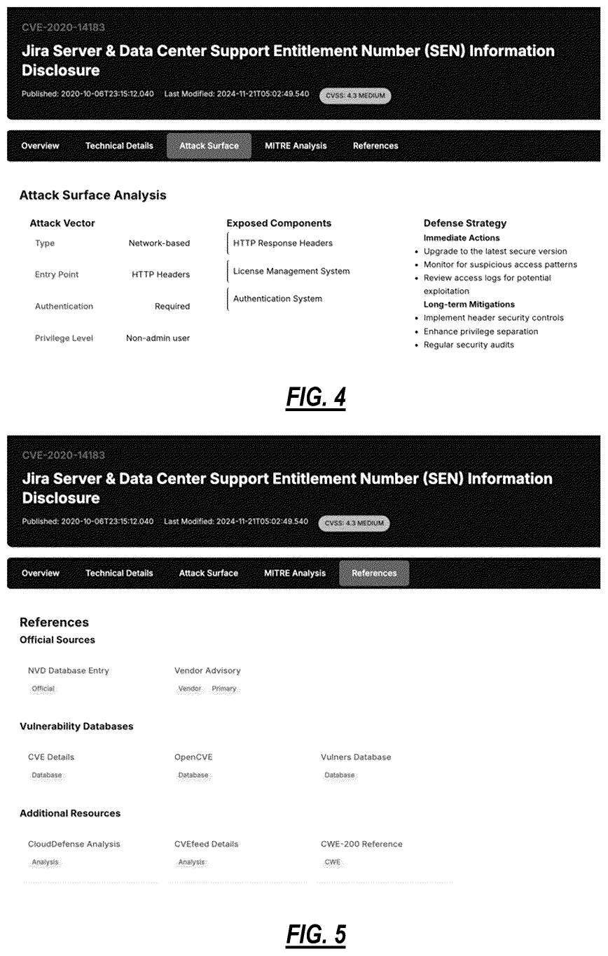

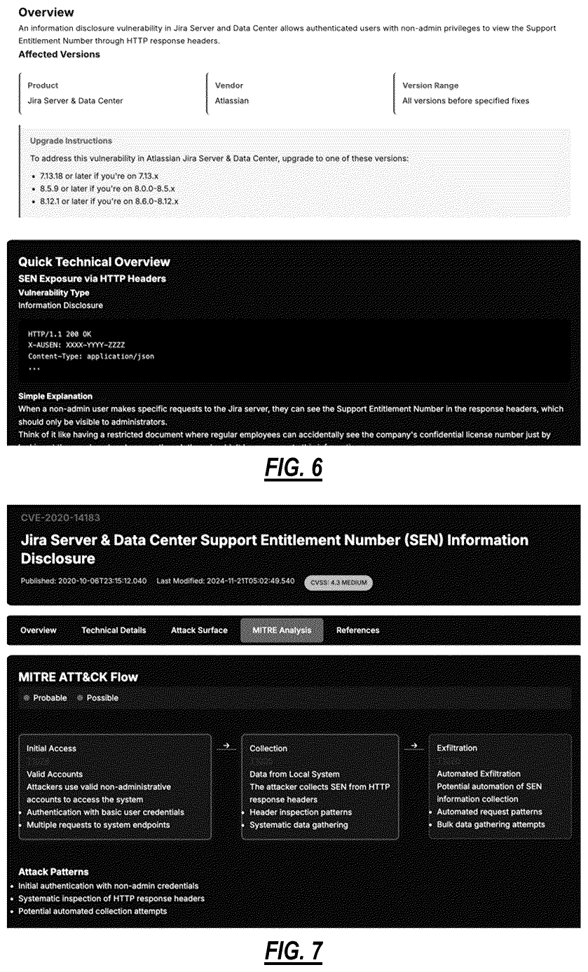

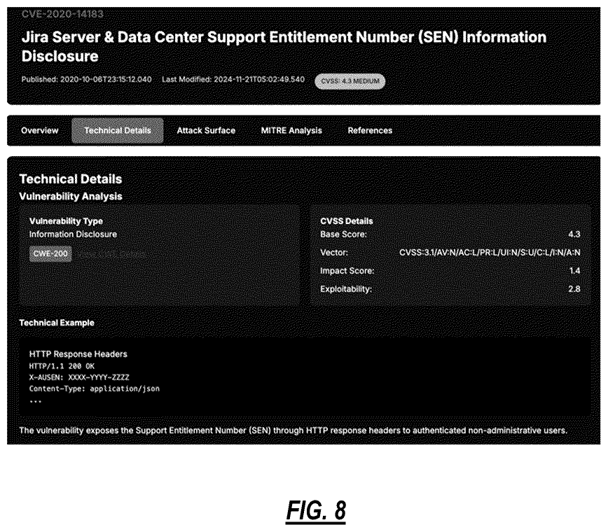

FIG. 4-FIG. 8 include various screenshots of an interactive User Interface (UI) for presenting enriched CVE information. The system can present each component through an interactive UI designed for clarity, usability, and actionable insights. Each component can be structured into collapsible sections, with high-level summaries visible upfront and detailed information accessible on demand. For example, the Publication Information component can use summary cards for CVE metadata, severity, and timelines, enriched with clickable links to external references and tooltips for additional context. The Overview Component can feature an interactive timeline of affected versions and an elaborated remediation guide in collapsible info boxes. The Quick Example component can include a split-screen layout with plain-language explanations on one side and technical code or flowcharts on the other, making it intuitive for users with varying expertise.

The CVE Exploitation component can display exploitation details through clear rankings, visual indicators like severity meters, and interactive graphs for exploitation popularity. Similarly, the Attack Surface Analysis component can visualize attack vectors, exposed components, and impacted areas using network diagrams or heatmaps, paired with tabs for immediate actions, architectural improvements, and monitoring recommendations. The MITRE ATT&CK Mapping component can adopt interactive tactic tiles or linked mapping graphs to show probable and possible tactics with clickable links to detailed techniques. Lastly, the MITRE ATT&CK Analysis component can organize detailed attacker workflows, associated techniques, related items, and potential mitigations in accordion-style layouts with embedded hyperlinks and flow diagrams for attack paths. By integrating interactivity, collapsibility, visual aids, and filtering options, the UI ensures an accessible and efficient experience for users, facilitating deep vulnerability analysis and cross-team collaboration.

The present disclosure represents a groundbreaking advancement in vulnerability analysis, redefining the traditionally labor-intensive and time-consuming process into an efficient, automated system for generating comprehensive security intelligence. By automatically producing enriched attributes and conducting multi-dimensional, in-depth analysis, the system dramatically reduces the time required for vulnerability assessments, from several hours to mere minutes, while ensuring consistency and accuracy across a wide range of CVE types. One of its standout features is its multi-level explanation framework, which tailors insights to various levels of expertise, from technical specialists to high-level security managers, facilitating clearer communication and fostering a better organization-wide understanding of security threats. This approach bridges knowledge gaps within teams, improving collaboration and decision-making at all levels of an organization.

By integrating with authoritative data sources and aligning with tactical frameworks, the system provides security teams with highly accurate, context-rich, and actionable intelligence. This enables faster, more informed decision-making and significantly improves vulnerability management efficiency. The structured output format, either in JSON format or the described UI, allows for seamless integration with existing security tools and workflows, further streamlining operational processes. Moreover, the comprehensive attack surface analysis, paired with tailored defense strategies, delivers immediate operational value, offering actionable recommendations to safeguard systems against potential exploits.

The system's ability to automate the generation of technical examples, exploitation scenarios, and practical mitigation strategies eliminates the need for time-intensive manual research, freeing security teams to focus on implementing protective measures rather than gathering and synthesizing information. As a result, organizations can significantly strengthen their security operations, enhance their ability to respond to threats proactively, and optimize resource allocation within their cybersecurity teams. By combining speed, accuracy, and depth of analysis, this invention transforms vulnerability management into a faster, more intelligent, and more effective process that is well-suited for the ever-evolving landscape of cybersecurity challenges.

### Automated CVE Enrichment Process

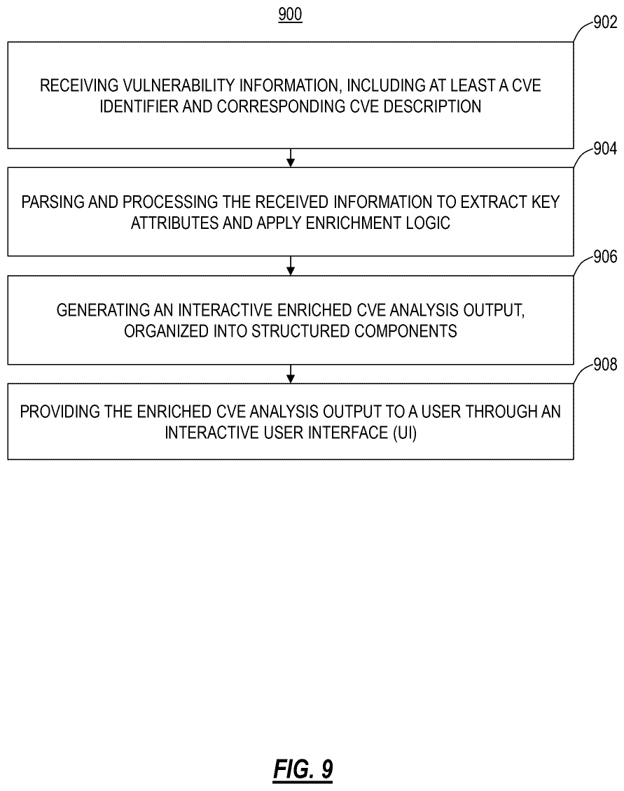

FIG. 9 is a flowchart of a process 900 for automated threat analysis and detection. In various embodiments, the process 900 can be implemented in multiple ways: as a method comprising distinct steps, via the computing system 100 configured to execute those steps, via a cloud system configured to do so, or through a non-transitory computer-readable medium that stores instructions causing one or more processors to perform the steps. This flexibility allows process 900 to be adapted to various system architectures and deployment scenarios.

In various embodiments, process 900 includes receiving vulnerability information, including at least a CVE identifier and corresponding CVE description (step 902); parsing and processing the received information to extract key attributes and apply enrichment logic (step 904); generating an interactive enriched CVE analysis output, organized into structured components (step 906); providing the enriched CVE analysis output to a user through an interactive user interface (UI) (step 908).

The process 900 can further include retrieving enriched technical and threat intelligence data from one or more external sources, the external sources including at least a vulnerability database, tactical security frameworks, and aggregated references. The external sources can include sources integrated via Application Programing Interfaces (APIs). Extracting key attributes and applying enrichment logic can include (i) generating structured metadata, including versioning impacts, scoring metrics, and vulnerability classifications, (ii) mapping the received CVE to probable and possible attacker tactics and techniques, and (iii) automatically generating additional contextual attributes, including attack surface analysis, potential exploitation scenarios, mitigation strategies, and technical recommendations. The structured components can include publication information, an overview, exploitation details, attack surface analysis, tactical security framework mapping, and tactical security frameworks analysis. The UI can include collapsible sections, visual diagrams, hyperlinks, and dynamic filtering for presenting probable and possible attack scenarios, associated mitigations, and hierarchical threat intelligence. The parsing and processing can include leveraging a natural language processing or Large Language Model (LLM) to extract relevant attributes and generate multi-level explanations tailored for technical and non-technical audiences. The output can include defense strategies including recommendations for immediate action, system-level architectural improvements, and ongoing monitoring strategies. The interactive UI can include a toggle option to switch between a “basic view” and an “advanced view” to adjust the level of detail presented based on the user's expertise. Providing enriched CVE analysis can include incorporating real-time updates from external data feeds to notify users of newly discovered patches, warnings, or changes to vulnerability's severity.

### Intelligent Security Alert Remediation Recommendations

The present disclosure further introduces an approach to delivering intelligent and context-aware security alert remediation recommendations by leveraging the capabilities of Large Language Models (LLMs) in combination with Retrieval-Augmented Generation (RAG) techniques. Seamlessly integrating with External Attack Surface Management (EASM) platforms, this solution provides dynamic and tailored remediation guidance through an interactive conversational interface. By addressing the complexities of modern security threats in real-time, the system significantly enhances the efficiency and responsiveness of security teams.

More particularly, the present systems and methods for intelligent and context-aware security alert remediation recommendations can be combined with the present cybersecurity threat detection system. Responsive to detecting a threat as described herein, the present systems can further provide remediation recommendations.

EASM platforms play a critical role in identifying vulnerabilities and threats across an organization's continually evolving attack surface. However, these platforms often generate a high volume of complex security alerts requiring prompt and appropriate remediation. Traditional alert management systems have struggled to keep pace, as they typically rely on static and generic recommendations that fail to account for the nuanced and specific context of each alert. This shortcoming leaves security teams with the cumbersome task of determining optimal remediation steps for each unique situation, while the ever-changing nature of cybersecurity threats exacerbates the challenge. Key limitations of current solutions include the lack of context-aware recommendations, an absence of interactive guidance, an inability to dynamically adapt to emerging threats, and minimal integration of historical remediation data into the decision-making process.

The proposed system addresses these challenges by combining several innovative features to transform how organizations approach security alert remediation. First, it leverages the advanced natural language capabilities of LLMs to analyze the specific details and context of each alert, enabling the generation of highly relevant and precise recommendations tailored to the organization's unique environment and risk posture. Further, through RAG techniques, the system dynamically incorporates the latest threat intelligence and historical remediation data into its outputs. This ensures that recommendations remain current, contextually informed, and responsive to both existing and emerging threats.

A standout feature is the system's interactive conversational interface, which enables security teams (users) to actively engage with the platform. Users can ask follow-up questions, refine remediation strategies, and validate their approach in real time, creating a dynamic and collaborative remediation process. Furthermore, by tightly integrating with EASM platforms, the system seamlessly becomes an extension of existing workflows. Security alerts generated by EASM tools, such as the described cybersecurity threat detection system, are automatically enriched with actionable insights and dynamic guidance, reducing manual effort and decision-making delays. The system also leverages historical remediation data, analyzing past responses to identify patterns of success and incorporating these insights into its recommendations, enabling the continuous improvement of organizational security practices over time.

By addressing the limitations of static, conventional alert management systems, this intelligent and adaptive remediation solution empowers security teams to operate with greater precision, speed, and confidence. It redefines the remediation process by transforming generic advice into context-sensitive recommendations, dynamically adapting to emerging threats, and fostering real-time collaboration through its interactive interface. As cyber threats continue to grow in both volume and sophistication, this system represents a significant leap forward in intelligent security operations. By ensuring organizations remain agile and well-prepared to protect their external attack surface and overall digital assets, this solution delivers a robust response to the evolving demands of modern cybersecurity.

The system incorporates a suite of sophisticated features designed to enhance the processing, analysis, and remediation of security alerts through intelligent automation and advanced data retrieval techniques. These features work synergistically to transform raw security alerts into actionable insights while continuously improving the system's capability to address evolving threats.

Alert reception and processing is the foundational step of the system, where incoming security alerts from EASM platforms are received and analyzed. The system extracts relevant metadata and contextual information from the alerts, enabling it to understand critical aspects such as affected assets, threat severity, and potential attack vectors. To optimize data usage and improve retrieval performance, the system creates vector embeddings for each alert, converting complex information into a machine-readable format that supports efficient searching and similarity matching in subsequent steps.

Knowledge base management is central to ensuring the system provides accurate and up-to-date remediation advice. The system maintains a structured database containing remediation recommendations for a wide array of security issues. This database is continually updated with new threat intelligence, ensuring the system remains current with the latest developments in cybersecurity. In addition to structured data, the system also stores historical remediation actions in the form of unstructured text, which preserves the richness and intricacy of real-world cases and provides valuable context for future recommendations.

The RAG Implementation leverages cutting-edge techniques to enhance the system's ability to deliver tailored remediation strategies. By performing vector similarity searches, the system rapidly identifies relevant historical cases and recommendations that align with the context of the incoming alert. It combines structured data, such as standard remediation steps, with unstructured data from historical cases, enabling the generation of nuanced insights that are both technically robust and contextually appropriate for the unique nature of each alert.

Response generation is where the system transforms retrieved data into actionable advice. It constructs context-aware prompts for the LLM, ensuring that the generated recommendations align with the specific circumstances of the alert and the organization's security posture. The system produces personalized remediation steps, tailored to the severity and relevance of the security issue, while maintaining conversation continuity when users engage with the interactive interface. This ensures security teams receive clear, actionable guidance throughout the remediation process.

Finally, continuous Learning ensures the system evolves to meet emerging threats and user needs. The knowledge base is regularly updated with new patterns and insights derived from incoming alerts and remediation efforts. User feedback is actively incorporated, enabling the system to learn from the experiences and preferences of security teams. This iterative process improves recommendation accuracy over time, making the system more effective and reliable with each use.

Through these interconnected steps, the system empowers security teams to efficiently analyze alerts, retrieve relevant information, and generate context-aware recommendations while continuously adapting to the dynamic landscape of cybersecurity threats.

In an example scenario, the EASM platform detects suspicious activity on a publicly exposed database server of a tenant, flagging multiple alerts related to an open port, a weak encryption protocol, and unauthorized login attempts. These alerts are then received and analyzed by the system to guide the security team in addressing the vulnerabilities efficiently. The process begins with the system ingesting the alerts and extracting detailed metadata, such as the affected asset, the nature of the vulnerabilities, and the severity of the threats. This data is converted into vector embeddings, which encode the semantic meaning of the alerts, enabling the system to conduct a similarity search against its knowledge base.

The system employs RAG techniques to enhance the depth and relevance of its recommendations. Using the vector embeddings, the system performs a similarity search across its knowledge base, retrieving both structured data, such as standard remediation procedures, and unstructured data, such as historical incident reports and case studies. For example, it can retrieve information about past incidents involving open database ports or brute-force login attempts on similar servers. The retrieved data is then aggregated and combined into a unified dataset, fusing technical remediation procedures with lessons learned from previous cases. This dynamic retrieval ensures that any recommendations provided will remain highly context-aware, grounded in both historical precedents and the specifics of the current threat scenario.

Using the enriched dataset from the RAG process, the system constructs finely tuned prompts for an LLM. The LLM then generates detailed, actionable, and context-sensitive remediation steps tailored specifically to the vulnerabilities identified in the alerts. For instance, the recommendations might include actions such as closing the open port using server firewall rules, upgrading encryption protocols to Transport Layer Security (TLS) 1.2 or above, implementing IP allow-listing for database access, and enabling Multi-Factor Authentication (MFA). These steps are presented to the security team in a way that aligns with the organization's risk posture and the complexity of the detected threats.

What makes the system particularly effective is its ability to seamlessly integrate remediation recommendations into the EASM platform itself. Using the LLM, the system translates technical solutions into natural language guidance that is specific to the EASM product's features. For example, it might instruct the user, “Log into the EASM platform's ‘Firewall Rules’ section and block port 3306 for all external IPs except those on the trusted list. Additionally, use the platform's ‘Encryption Scanner’ to upgrade any insecure protocols on the database server.” By doing this, the system not only offers advice but also illustrates how to implement the remediation directly within the EASM tool, removing ambiguity and accelerating action.

The system's functionality is further elevated through its interactive conversational interface, which allows security team members to engage in real-time dialogue with the system. For example, a security analyst might ask, “What's the quickest way to block unauthorized login attempts?” The system could respond with, “Enable IP filtering in the EASM platform's ‘Access Controls’section to block unauthorized login attempts. Would you like detailed instructions to automate this policy?” If the user confirms, the system provides step-by-step guidance, ensuring clarity and ease of implementation. This conversational capability fosters a collaborative environment where the security team can clarify queries, request further details, or refine strategies, all within the interactive interface.

By combining context-aware RAG processing, LLM-generated recommendations, seamless integration with EASM workflows, and real-time conversational guidance, the system offers a comprehensive, intelligent solution to manage security alerts effectively. This workflow not only reduces remediation time but empowers security teams to make informed decisions with greater precision and confidence, minimizing threats and safeguarding critical assets. Through the integration of dynamic retrieval, adaptive learning, and a user-friendly interface, the system redefines the approach to addressing modern cybersecurity challenges.

### Process for Providing Intelligent Security Alert Remediation Recommendations

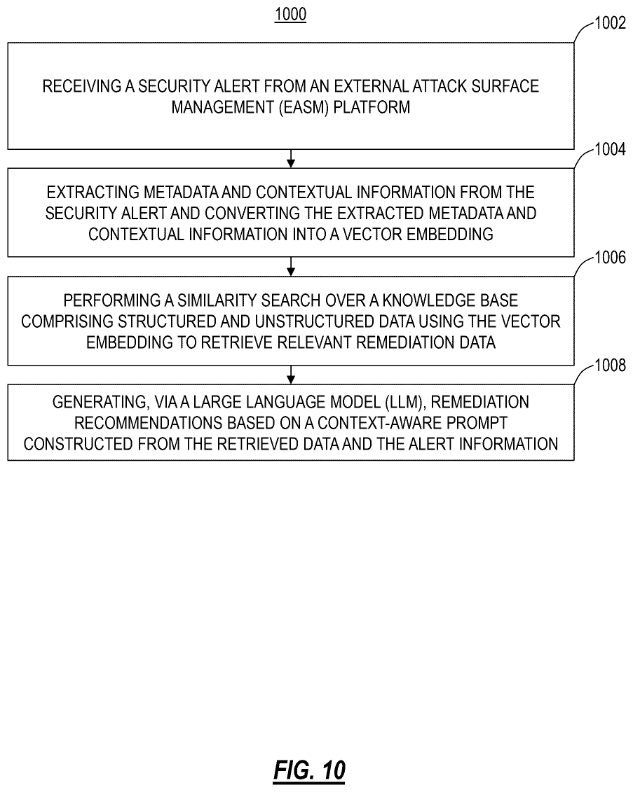

FIG. 10 is a flowchart of a process 1000 for providing intelligent security alert remediation recommendations. In various embodiments, the process 1000 can be implemented in multiple ways: as a method comprising distinct steps, via the computing system 100 configured to execute those steps, via a cloud system configured to do so, or through a non-transitory computer-readable medium that stores instructions causing one or more processors to perform the steps. This flexibility allows process 1000 to be adapted to various system architectures and deployment scenarios.

The process 1000 includes receiving a security alert from an External Attack Surface Management (EASM) platform (step 1002); extracting metadata and contextual information from the security alert and converting the extracted metadata and contextual information into a vector embedding (step 1004); performing a similarity search over a knowledge base comprising structured and unstructured data using the vector embedding to retrieve relevant remediation data (step 1006); and generating, via a Large Language Model (LLM), remediation recommendations based on a context-aware prompt constructed from the retrieved data and the alert information (step 1008).

The process 1000 can further include presenting the remediation recommendations through an interactive conversational interface. The steps can include receiving user input via the interactive conversational interface and providing follow-up guidance based thereon. The steps can include integrating the remediation recommendations with workflows and features of the EASM platform for implementation. The knowledge base can be continually updated with threat intelligence and historical remediation data. The steps can include updating the knowledge base with newly generated recommendations and associated outcomes and incorporating updates into future processes to enhance recommendation precision. The steps can include incorporating user feedback into the knowledge base to improve future recommendations. Remediation recommendations can be dynamically adapted to an organization's risk posture and emerging cybersecurity threats. The steps can include enabling the user to request automation scripts or detailed instructions for implementing the remediation within the EASM platform. The steps can include aggregating structured data and unstructured data retrieved via Retrieval-Augmented Generation (RAG) into a unified dataset for input to the LLM.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for providing intelligent alert remediation recommendation, the method comprising steps of:
receiving a security alert from an External Attack Surface Management (EASM) platform;
extracting metadata and contextual information from the security alert and converting the extracted metadata and contextual information into a vector embedding;
performing a similarity search over a knowledge base comprising structured and unstructured data using the vector embedding to retrieve relevant remediation data; and
generating, via a Large Language Model (LLM), remediation recommendations based on a context-aware prompt constructed from the retrieved data and the alert information.

2. The method of claim 1, wherein the steps include presenting the remediation recommendations through an interactive conversational interface.

3. The method of claim 2, wherein the steps include receiving user input via the interactive conversational interface and providing follow-up guidance based thereon.

4. The method of claim 1, wherein the steps include integrating the remediation recommendations with workflows and features of the EASM platform for implementation.

5. The method of claim 1, wherein the knowledge base is continually updated with threat intelligence and historical remediation data.

6. The method of claim 1, further comprising updating the knowledge base with newly generated recommendations and associated outcomes and incorporating updates into future processes to enhance recommendation precision.

7. The method of claim 1, further comprising incorporating user feedback into the knowledge base to improve future recommendations.

8. The method of claim 1, wherein remediation recommendations are dynamically adapted to an organization's risk posture and emerging cybersecurity threats.

9. The method of claim 1, further comprising enabling a user to request automation scripts or detailed instructions for implementing the remediation within the EASM platform.

10. The method of claim 1, wherein the steps include aggregating structured data and unstructured data retrieved via Retrieval-Augmented Generation (RAG) into a unified dataset for input to the LLM.

11. A non-transitory computer-readable storage medium having computer-readable code stored thereon for programming one or more processors to perform steps of:
receiving a security alert from an External Attack Surface Management (EASM) platform;
extracting metadata and contextual information from the security alert and converting the extracted metadata and contextual information into a vector embedding;
performing a similarity search over a knowledge base comprising structured and unstructured data using the vector embedding to retrieve relevant remediation data; and
generating, via a Large Language Model (LLM), remediation recommendations based on a context-aware prompt constructed from the retrieved data and the alert information.

12. The non-transitory computer-readable storage medium of claim 11, wherein the steps include presenting the remediation recommendations through an interactive conversational interface.

13. The non-transitory computer-readable storage medium of claim 12, wherein the steps include receiving user input via the interactive conversational interface and providing follow-up guidance based thereon.

14. The non-transitory computer-readable storage medium of claim 11, wherein the steps include integrating the remediation recommendations with workflows and features of the EASM platform for implementation.

15. The non-transitory computer-readable storage medium of claim 11, wherein the knowledge base is continually updated with threat intelligence and historical remediation data.

16. The non-transitory computer-readable storage medium of claim 11, further comprising updating the knowledge base with newly generated recommendations and associated outcomes and incorporating updates into future processes to enhance recommendation precision.

17. The non-transitory computer-readable storage medium of claim 11, further comprising incorporating user feedback into the knowledge base to improve future recommendations.

18. The non-transitory computer-readable storage medium of claim 11, wherein remediation recommendations are dynamically adapted to an organization's risk posture and emerging cybersecurity threats.

19. The non-transitory computer-readable storage medium of claim 11, further comprising enabling a user to request automation scripts or detailed instructions for implementing the remediation within the EASM platform.

20. The non-transitory computer-readable storage medium of claim 11, wherein the steps include aggregating structured data and unstructured data retrieved via Retrieval-Augmented Generation (RAG) into a unified dataset for input to the LLM.
